(19) United States
(12) Patent Application Publication
(10) Pub. No.: US 2014/0231686 A1
(43) Pub. Date: Aug. 21, 2014

(54) SOLENOID PLUNGER

(71) Applicant: William H. Keizer, Brantford (CA)

(72) Inventor: William H. Keizer, Brantford (CA)

(21) Appl. No.: 14/259,495

(22) Filed: Apr. 23, 2014

Related U.S. Application Data
(63) Continuation of application No. 12/880,016, filed on Sep. 10, 2010, now abandoned.

(51) Int. Cl. F16K 31/06

(52) U.S. Cl. CPC F16K 31/06
USPC 251/129.15; 29/890.121

(57) ABSTRACT

A solenoid plunger for a solenoid-driven metering system comprises a solenoid-actuable armature shaft and a plunger head secured to a first end of the armature shaft. The plunger head comprises a campanulate portion whose wide end is further from the first end of the armature shaft than its narrow end, and a closure member further from the first end of the armature shaft than the campanulate portion. The closure member defines a first end of the plunger head. The second end of the plunger head has a threaded shaft and the first end of the armature shaft has a threaded bore, and the plunger head is secured to the first end of the armature shaft by the threaded shaft being threadedly received in the threaded bore. The plunger head may be made from metal, preferably from aluminum or an aluminum alloy.

### CROSS-REFERENCE TO RELATED APPLICATIONS

This application is a Continuation of U.S. application Ser. No. 12/880,016, filed on Sep. 10, 2010, entitled “SOLENOID PLUNGER,” the entirety of which is incorporated herein by reference.

### FIELD OF INVENTION

The present invention relates to solenoid plungers, and more particularly to solenoid plungers for use in solenoid-driven metering systems for liquid and granular material.

### BACKGROUND OF THE INVENTION

Solenoid-driven metering systems are well known in the food service arts, and are used for metered dispensing of liquids such as cream and milk, and granular solids such as sugar, for beverages such as coffee and tea. Such systems are sold under the trademark SureShot Dispensing Systems® by A.C. Dispensing Equipment Inc., having an address at 100 Dispensing Way, Lower Sackville, Nova Scotia, Canada B4C 4H2.

FIGS. 1 to 3 show an exemplary prior art solenoid-driven metering system 10. The metering system 10 comprises a flexible tube 12, a housing 14 surrounding a portion of the flexible tube 12, and a solenoid plunger 16. Other components of the solenoid-driven metering system, such as the solenoid itself, related control systems, the support structure and other elements have been omitted for clarity of illustration; these elements and their placement will be apparent to one skilled in the art.

Referring specifically to FIG. 1, an upper end 12A of the flexible tube 12 communicates with a reservoir of the material to be metered (not shown) and a lower end 12B communicates with an outlet (not shown), which may simply be an open end of the tube 12. The tube 12 is arranged generally vertically, with the upper end 12A above the lower end 12B, so that material will flow downwardly through the tube from the upper end 12A to the lower end 12B under the influence of gravity, unless the tube 12 is constricted.

The housing 14 comprises two opposed halves 14A, 14B hingedly secured to one another in a clamshell arrangement by a hinge 18 and secured around the flexible tube 12 in a closed configuration by bolts or other suitable fasteners. Two opposed channels 20A, 20B defined in the inner faces of the two opposed halves 14A, 14B cooperate to define a vertical passageway 20 through the housing 14 for the flexible tube 12. The half 14A of the housing 14 facing the solenoid plunger 16 has an aperture 22 which exposes the flexible tube 12.

The solenoid plunger 16 comprises a solenoid-actuable armature shaft 24 and a plunger head 26 secured to one end of the armature shaft 24. The plunger head 26 is formed from plastic and comprises a base 28 secured to the armature shaft 24, four support members 30, a disc-shaped portion 32 and a closure member 34. The support members 30 are ogee-shaped and arranged in cruciform relation to one another, and extend outwardly from the base 28 to support the disc-shaped portion 30, which in turn supports the closure member 34.

When assembled, the aperture 22 in the half 14A of the housing 14 facing the solenoid plunger 16 is in registration with the closure member 34 on the plunger head 26.

In operation, as shown in FIGS. 2A and 2B, the solenoid plunger 16 is arranged for reciprocal motion toward and away from the housing 14 under the control of the solenoid (not shown).

The “resting” or “closed” position of the solenoid plunger 16 is shown in FIG. 2A; in this position the closure member 34 on the plunger head 26 has been received in the aperture 22 in the half 14A of the housing 14 facing the solenoid plunger 16, and the plunger 16 may be maintained in this position by, for example, a suitable biasing member such as a spring (not shown). In this position, the closure member 34 compresses the flexible tube 12 and pinches it against the back wall 36 of the passageway 20 defined by the channels 20A, 20B (FIG. 1) in the two halves 14A, 14B of the housing 14. This pinching of the flexible tube 12 substantially completely obstructs the flexible tube 12, inhibiting material flow past the closure member 34.

When it is desired to dispense material, the solenoid (not shown) is actuated to move the solenoid plunger 16 into the “active” or “open” position, as shown in FIG. 2B, for a fixed period of time before disengaging the solenoid and allowing the solenoid plunger 16 to return to the “rest” or “closed” position shown in FIG. 2A. During the period of time that the solenoid plunger 16 is in the “active” or “open” position (FIG. 2B), the flexible tube 12 is unobstructed and a predetermined volume of liquid or granular material is able to move past the position of the solenoid plunger 16 before the flexible tube 12 is again obstructed as the solenoid plunger 16 returns to the “rest” or “closed” position (FIG. 2A).

The plunger head 26 is secured to the armature shaft 24 by way of a tab 38 extending from the base 28 of the plunger head 26 and which is received in a corresponding slot 40 at the end of the armature shaft 25 and held in place by a rivet 42. Because of the stresses applied during repeated impact between the plunger head 26 and the back wall 36 of the passageway 20 in the housing 14, the tab 38 tends to fracture adjacent the base 28, separating the plunger head 26 from the armature shaft 24 as shown in FIG. 3. When this occurs, the entire solenoid plunger 16 must be discarded and replaced. This requires a costly service call, and also requires the machine containing the metering system to be taken out of service, which can hamper efficiency in a high-volume restaurant such as a busy coffee shop.

### SUMMARY OF THE INVENTION

The shape of the plunger head of a solenoid plunger, and the structure by which the plunger head is secured to the armature shaft, have been significantly improved.

In one embodiment, the present invention is directed to a solenoid plunger for a solenoid-driven metering system. The solenoid plunger comprises a solenoid-actuable armature shaft and a plunger head secured to the first end of the armature shaft. The plunger head comprises a campanulate portion having a wide end and a narrow end, with the wide end further from the first end of the armature shaft than the narrow end, and a closure member further from the first end of the armature shaft than the campanulate portion and defining a first end of the plunger head.

The plunger head is preferably formed from metal, and more preferably from a metal selected from the group consisting of aluminum and aluminum alloys.

In a preferred embodiment, the second end of the plunger head has a threaded shaft coaxial with the longitudinal axis of the campanulate portion of the plunger head and the first end of the armature shaft has a threaded bore defined therein, coaxial with the longitudinal axis of the armature shaft. The plunger head is secured to the first end of the armature shaft by way of the threaded shaft being threadedly received in the threaded bore. The plunger head may be further secured to the first end of the armature shaft by a pin passing through a crossbore extending through the threaded shaft and the threaded bore, perpendicularly to the longitudinal axes thereof.

In an embodiment, the plunger head further comprises a cylindrical portion disposed between the narrow end of the campanulate portion and the first end of the armature shaft.

In an embodiment, the plunger head further comprises a disc-shaped portion disposed between the wide end of the campanulate portion and the closure member. The closure member may be an H-shaped member extending from the disc-shaped portion and tapering into a wedge distal from the disc-shaped portion.

In an embodiment, the armature shaft includes an annular groove on the outer surface thereof. The second end of the armature shaft may define a frusto-conical tip.

In another aspect, the present invention is directed to a method of modifying a solenoid-driven metering system. The method comprises the steps of removing an unbroken OEM solenoid plunger from the metering system and installing a replacement solenoid plunger according to an aspect of the present invention in the metering system.

### BRIEF DESCRIPTION OF THE DRAWINGS

These and other features of the invention will become more apparent from the following description in which reference is made to the appended drawings wherein:

FIG. 1 is a perspective view showing a portion of a prior art solenoid-based metering system including a prior art solenoid plunger;

FIG. 2A is a side view of the portion of the prior art metering system of FIG. 1, showing the prior art solenoid plunger in a first position that permits flow of material through the prior art metering system;

FIG. 2B is a side view of the portion of the prior art metering system of FIG. 1, showing the prior art solenoid plunger in a second position that inhibits flow of material through the prior art metering system;

FIG. 3 is a side view of the prior art solenoid plunger showing a primary failure mode thereof;

FIG. 4A is a side view of an embodiment of a solenoid plunger according to an aspect of the present invention;

FIG. 4B is an exploded perspective view of the solenoid plunger of FIG. 4A; and

FIG. 5 is a flowchart showing a method of modifying a solenoid-driven metering system, according to an aspect of the present invention.

### DETAILED DESCRIPTION

Reference is now made to FIGS. 4A and 4B, in which an exemplary embodiment of a solenoid plunger according to an aspect of the present invention is shown generally at 100. The solenoid plunger 100 is suitable for use in a solenoid-driven metering system.

The solenoid plunger 100 comprises a solenoid-actuable armature shaft 124 and a plunger head 126 secured to a first end 124A of the armature shaft 124. The plunger head 126 is preferably formed from metal, and more preferably from aluminum or an aluminum alloy to provide strength at a low weight, and comprises a cylindrical portion 134, a campanulate or bell-shaped portion 128, a disc-shaped portion 132 and a closure member 130. The campanulate portion 128 has a wide end 128A and a narrow end 128B, with the wide end 128A being further from the first end 124A of the armature shaft 124 than the narrow end 128B. The closure member 130 is further from the first end 124A of the armature shaft 124 than the campanulate portion 128 and defines a first end 126A of the plunger head. The cylindrical portion 134 is disposed between the narrow end 128B of the campanulate portion 128 and the first end 124A of the armature shaft 124, and the disc-shaped portion 132 is disposed between the wide end 128A of the campanulate portion 128 and the closure member 130. The cylindrical portion 134, campanulate portion 128 and disc-shaped portion 132 are all longitudinally coaxial with one another, with the cylindrical portion 134 having a substantially smaller diameter than the disc-shaped portion 132 and being substantially longer than the disc-shaped portion 132, measured in the longitudinal direction. The narrow end 128B of the campanulate portion 128 has approximately the same diameter as the cylindrical portion 134, with the wide end 128A of the campanulate portion 128 having a substantially greater diameter than that of the cylindrical portion 134.

The campanulate portion 128 includes a cylindrical region 140 at the wide end 128A thereof, adjacent the disc-shaped portion 132 and having a smaller diameter than the disc-shaped portion 132 so as to define an annular shoulder 142 between the campanulate portion 128 and the disc-shaped portion 132. As best seen in FIG. 4B, the closure member 130 is an H-shaped member extending from the disc-shaped portion 132 and tapering into a wedge 144 distal from the disc-shaped portion 132. More particularly, the closure member 130 comprises two opposed flanges 146 connected by a web 148, with the flanges 146 tapering inwardly toward the web 126 to form the wedge 144 at the end of the closure member 130 that is distal from the disc-shaped portion 132. The nose 150 of the wedge 144 is blunt so as not to rupture a flexible tube of a solenoid-driven metering system.

The armature shaft 124 is cylindrical and includes an annular groove 152 on the outer surface thereof for receiving a stop (not shown), and the second end 124B of the armature shaft defines a frusto-conical tip 154.

Referring now to FIG. 4B, it can be seen that a threaded shaft 156 extends from the second end 126B of the plunger head 126, longitudinally coaxial with the cylindrical portion 134, campanulate portion 128 and disc-shaped portion 132 of the plunger head 126. The threaded shaft 156 is preferably integrally formed as part of the plunger head 126. Correspondingly, the first end 124A of the armature shaft 124 has a threaded bore 158 defined therein, coaxial with the longitudinal axis of the armature shaft 124. The plunger head 126 is secured to the first end 124A of the armature shaft 124 by the threaded shaft 156 being threadedly received in the threaded bore 158, and is further secured to the first end 124A of the armature shaft 124 by a pin 160 passing through a crossbore. The crossbore is defined by a first passage 162 extending through the threaded shaft, perpendicular to the longitudinal axis thereof and a second passage 164 extending through the threaded bore, perpendicular to the longitudinal axis thereof. When the threaded shaft 156 is fully threaded into the threaded bore 158, the first and second passages 162, 164 are in registration with one another to define the complete crossbore. The pin 160 may, for example, be friction fit or interference fit into the first and second passages 162, 164 or the pin 160 and the first and second passages 162, 164 may be threaded.

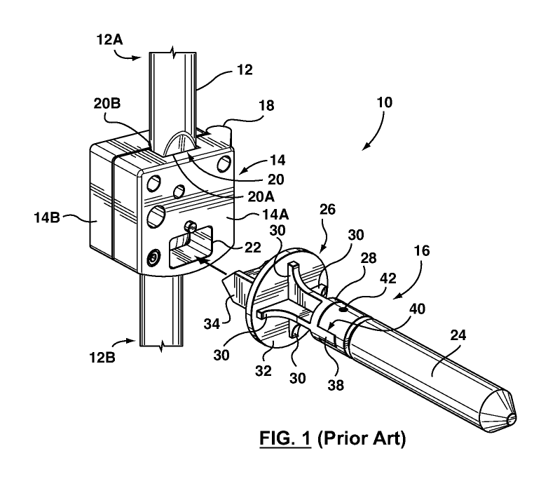

A solenoid plunger according to an aspect of the present invention, such as the solenoid plunger 100 shown in FIGS. 4A and 4B, is significantly less prone to breakage than the prior art solenoid plunger 16 shown in FIGS. 1 to 3.

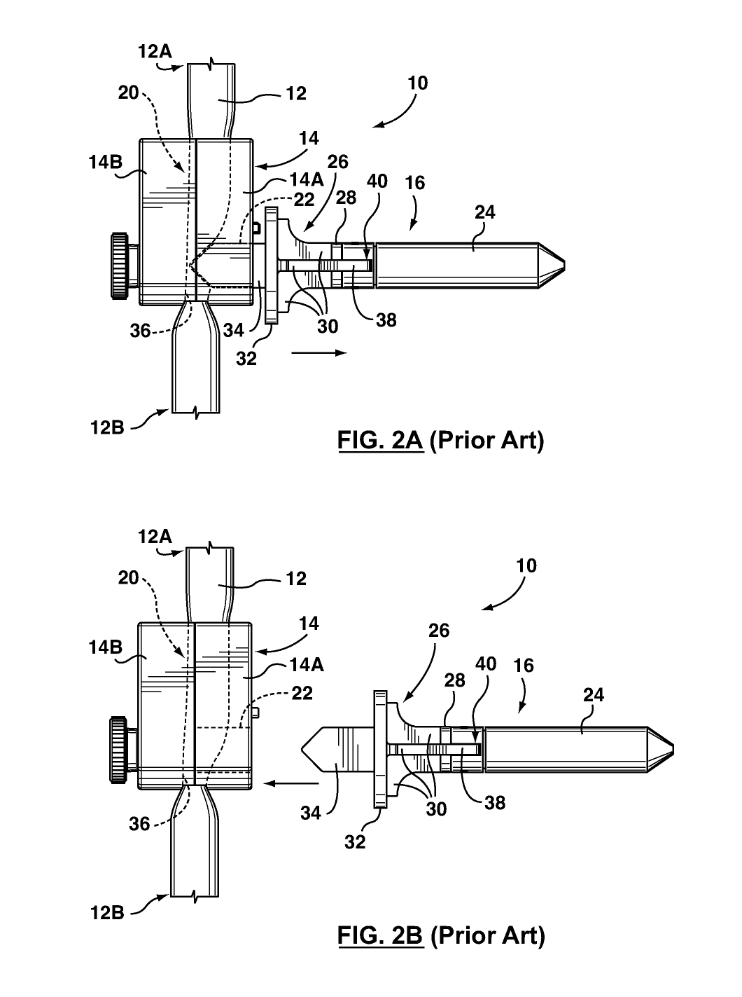

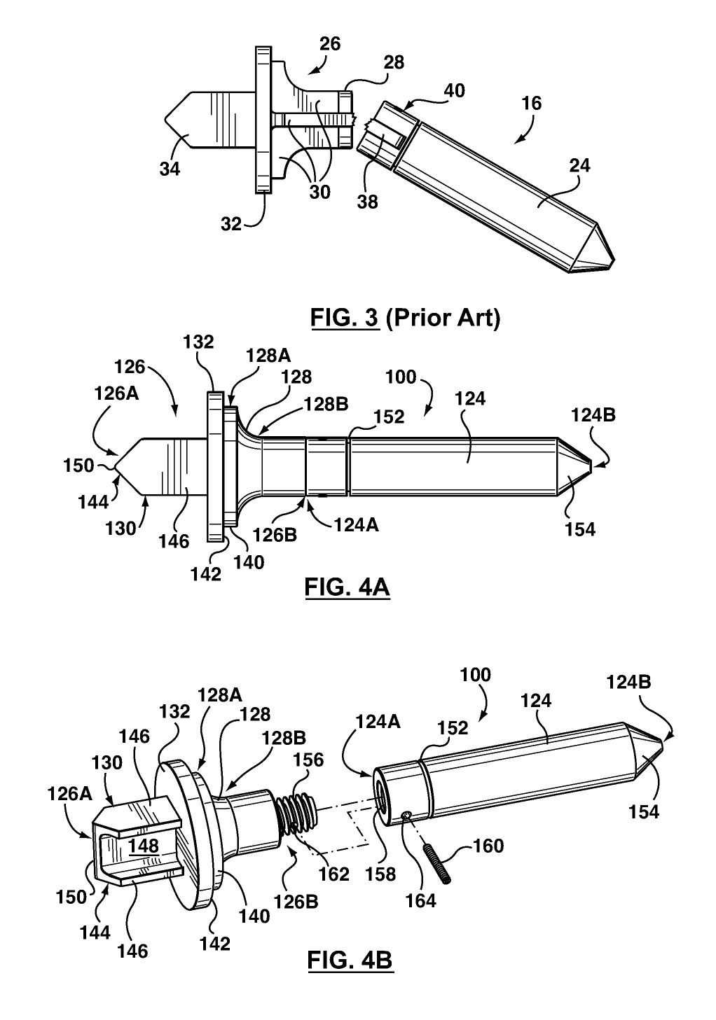

A solenoid plunger according to an aspect of the present invention, such as that described above in respect of FIGS. 4A and 4B, may be used to replace an original equipment manufacturer (OEM) solenoid plunger such as that shown in FIGS. 1 to 2B after the latter has broken as shown in FIG. 3. Alternatively, in order to avoid the downtime and service call costs associated with a broken OEM solenoid plunger, an OEM solenoid plunger such as that shown in FIGS. 1 to 2B may be replaced, before it has broken, with a solenoid plunger according to an aspect of the present invention, such as that described above in respect of FIGS. 4A and 4B.

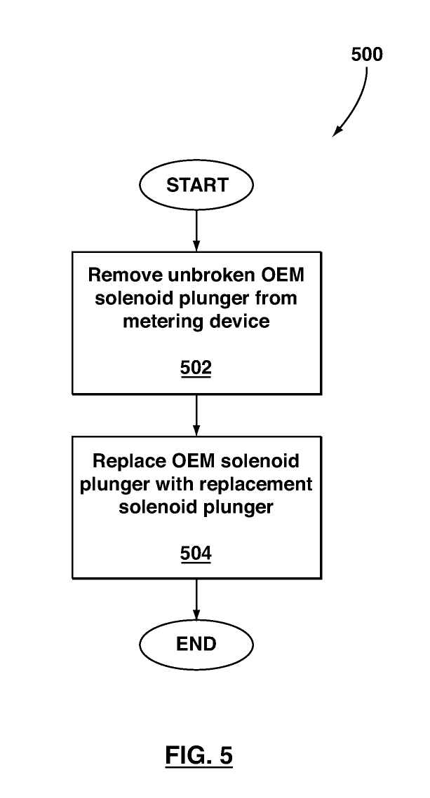

In FIG. 5, an exemplary method of modifying a solenoid-driven metering system is shown generally at 500. At step 502, a user such as a restaurant operator or employee or a third party repair technician removes an unbroken OEM solenoid plunger, such as the solenoid plunger 16 shown in FIGS. 1 to 2B, from the metering system. At step 504, the user installs a replacement solenoid plunger according to an aspect of the present invention, such as the solenoid plunger 100 shown in FIGS. 4A and 4B, in the metering system.

A currently preferred embodiment has been described by way of example. It will be apparent to persons skilled in the art that a number of variations and modifications can be made without departing from the scope of the invention as defined in the claims.

What is claimed is:

1. A solenoid plunger for a solenoid-driven metering system, comprising:
a solenoid-actuable armature shaft; and
a plunger head secured to a first end of the armature shaft; the plunger head comprising:
a campanulate portion having a wide end and a narrow end and wherein the wide end is further from the first end of the armature shaft than the narrow end; and
a closure member further from the first end of the armature shaft than the campanulate portion and defining a first end of the plunger head.

2. The plunger of claim 1 wherein the plunger head is formed from metal.

3. The plunger of claim 2 wherein the metal is selected from the group consisting of aluminum and aluminum alloys.

4. The plunger of claim 3, wherein:
a second end of the plunger head has a threaded shaft coaxial with a longitudinal axis of the campanulate portion of the plunger head;
the first end of the armature shaft has a threaded bore defined therein, the threaded bore being coaxial with a longitudinal axis of the armature shaft; and
the plunger head is secured to the first end of the armature shaft by the threaded shaft being threadedly received in the threaded bore.

5. The plunger of claim 4, wherein the plunger head further comprises a cylindrical portion disposed between the narrow end of the campanulate portion and the first end of the armature shaft.

6. The plunger of claim 5, wherein the plunger head further comprises a disc-shaped portion disposed between the wide end of the campanulate portion and the closure member.

7. The plunger of claim 6, wherein the plunger head is further secured to the first end of the armature shaft by a pin passing through a crossbore extending through the threaded shaft and the threaded bore perpendicularly to the longitudinal axes thereof.

8. The plunger of claim 7, wherein the armature shaft includes an annular groove on the outer surface thereof.

9. The plunger of claim 8, wherein a second end of the armature shaft defines a frusto-conical tip.

10. The plunger of claim 9, wherein the closure member is an H-shaped member extending from the disc-shaped portion and tapering into a wedge distal from the disc-shaped portion.

11. A method of modifying a solenoid-driven metering system; comprising the steps of:
(a) removing an unbroken OEM solenoid plunger from the metering system; and
(b) installing a replacement solenoid plunger in the metering system; wherein the replacement solenoid plunger comprises:
a solenoid-actuable armature shaft; and
a plunger head secured to a first end of the armature shaft; the plunger head comprising:
a campanulate portion having a wide end and a narrow end and wherein the wide end is further from the first end of the armature shaft than the narrow end; and
a closure member further from the first end of the armature shaft than the campanulate portion and defining a first end of the plunger head.

12. The method of claim 11 wherein the plunger head is formed from metal.

13. The method of claim 12 wherein the metal is selected from the group consisting of aluminum and aluminum alloys.

14. The method of claim 13, wherein:
a second end of the plunger head has a threaded shaft coaxial with a longitudinal axis of the campanulate portion of the plunger head;
the first end of the armature shaft has a threaded bore defined therein, the threaded bore being coaxial with a longitudinal axis of the armature shaft; and
the plunger head is secured to the first end of the armature shaft by the threaded shaft being threadedly received in the threaded bore.

15. The method of claim 14, wherein the plunger head further comprises a cylindrical portion disposed between the narrow end of the campanulate portion and the first end of the armature shaft.

16. The method of claim 15, wherein the plunger head further comprises a disc-shaped portion disposed between the wide end of the campanulate portion and the closure member.

17. The method of claim 16, wherein the plunger head is further secured to the first end of the armature shaft by a pin passing through a crossbore extending through the threaded shaft and the threaded bore perpendicularly to the longitudinal axes thereof.

18. The method of claim 17, wherein the armature shaft includes an annular groove on the outer surface thereof.

19. The method of claim 18, wherein a second end of the armature shaft defines a frusto-conical tip.

20. The method of claim 19, wherein the closure member is an H-shaped member extending from the disc-shaped portion and tapering into a wedge distal from the disc-shaped portion.
